(19) United States
(12) Patent Application Publication
(10) Pub. No.: US 2009/0095734 A1
(43) Pub. Date: Apr. 16, 2009

(54) SURFACE MOUNT RESISTOR HEATING APPARATUS

(76) Inventor: Chien-Chou Chen, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/949,030

(22) Filed: Dec. 1, 2007

(30) Foreign Application Priority Data
Oct. 15, 2007 (CN) 200720183411.4

(51) Int. Cl. H05B 3/06

(52) U.S. Cl. 219/540

(57) ABSTRACT

A surface mount resistor heating apparatus includes a heater including two copper foil plates electrically connected to two electric wires, and at least two surface mount resistors electrically connected between the two copper foil plates. When a low voltage electric power is applied onto the heater, the heater produces a temperature by an impedance of the at least two surface mount resistors to achieve a heating purpose. Thus, the two copper foil plates can change and diffuse a spot-type temperature distribution of each of the at least two surface mount resistors into a planar-type temperature distribution to distribute the temperature evenly and smoothly so as to instantly reduce the higher temperature produced by the at least two surface mount resistors to a determined temperature that is comfortable to a user.

### BACKGROUND OF THE INVENTION

1. Field of the Invention

The present invention relates to a heating apparatus and, more particularly, to a surface mount resistor heating apparatus.

2. Description of the Related Art

A conventional heating apparatus comprises a heating filament connected to a power supply, and an enclosure enclosed around the heating filament. Thus, when the power supply applies an electric power to the heating filament, the heating filament produces a determined heat or temperature by its resistance to achieve a heating purpose. When in use, the enclosure is attached by sewing to an article, such as a glove, clothing, hat, shoe cushion and the like, so as to heat the article by the heating filament.

### BRIEF SUMMARY OF THE INVENTION

In accordance with the present invention, there is provided a surface mount resistor heating apparatus, comprising a heater including two copper foil plates having a determined length and width and electrically connected to positive and negative electrodes of two electric wires, and at least two surface mount resistors electrically connected between the two copper foil plates, wherein when a low voltage electric power is applied onto the heater, the heater produces a temperature by an impedance of the at least two surface mount resistors to achieve a heating purpose.

The primary objective of the present invention is to provide a surface mount resistor heating apparatus that produces a proper temperature by an impedance of at least two surface mount resistors to achieve a heating purpose.

Another objective of the present invention is to provide a surface mount resistor heating apparatus, wherein each of the two copper foil plates can conduct the heat produced by the at least two surface mount resistors so that the higher temperature produced by the at least two surface mount resistors is distributed and diffused on each of the two copper foil plates evenly and quickly.

A further objective of the present invention is to provide a surface mount resistor heating apparatus, wherein the two copper foil plates can change and diffuse a spot-type temperature distribution of each of the at least two surface mount resistors into a planar-type temperature distribution to distribute the temperature evenly and smoothly so as to instantly reduce the higher temperature produced by the at least two surface mount resistors to a determined temperature that is comfortable to a user.

A further objective of the present invention is to provide a surface mount resistor heating apparatus, wherein the surface mount resistor heating apparatus has waterproof and heat insulating functions.

A further objective of the present invention is to provide a surface mount resistor heating apparatus, wherein the heat produced by the at least two surface mount resistors is distributed and diffused by each of the two copper foil plates, then absorbed by the two cloth pieces respectively and finally released outwardly from the two cloth pieces respectively, so that the surface mount resistor heating apparatus has a temperature profile that is distributed evenly and smoothly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view of a surface mount resistor heating apparatus in accordance with the preferred embodiment of the present invention.

FIG. 2 is a front view of a surface mount resistor heating apparatus in accordance with another preferred embodiment of the present invention.

FIG. 3 is a side cross-sectional view of a surface mount resistor heating apparatus in accordance with another preferred embodiment of the present invention.

### DETAILED DESCRIPTION OF THE INVENTION

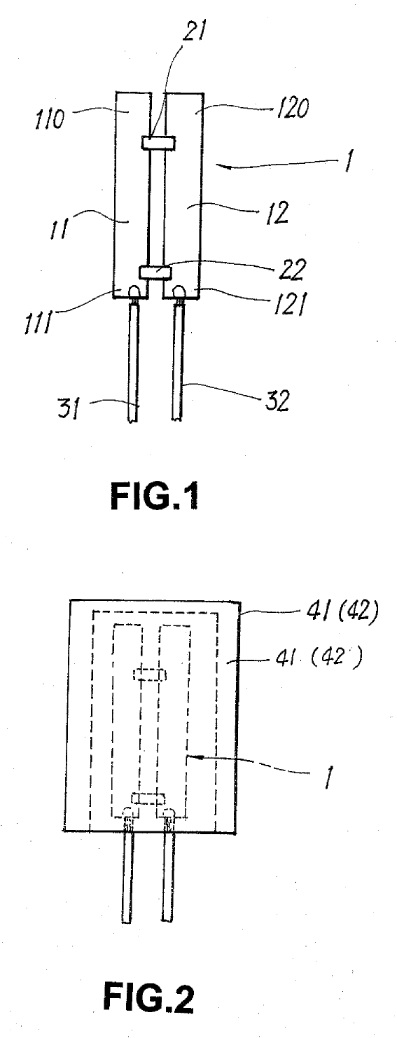

Referring to the drawings and initially to FIG. 1, a surface mount resistor heating apparatus in accordance with the preferred embodiment of the present invention comprises a heater 1. The heater 1 includes two copper foil plates 11 and 12, two electric wires 31 and 32 electrically connected to the two copper foil plates 11 and 12 respectively, and at least two surface mount resistors 21 and 22 electrically connected between the two copper foil plates 11 and 12. In such a manner, when a low voltage electric power (lower than 30 VDC) is applied onto the heater 1, the heater 1 produces a determined temperature by an impedance of the at least two surface mount resistors 21 and 22 to achieve a heating purpose.

Each of the two copper foil plates 11 and 12 has a determined length and width. Each of the two copper foil plates 11 and 12 functions as a conductor to transmit an electric current or to conduct a heat. Each of the at least two surface mount resistors 21 and 22 is connected between the two copper foil plates 11 and 12 by soldering.

In practice, when a single surface mount resistor is used individually, the single surface mount resistor has a spot-type temperature distribution so that the heat produced by the single surface mount resistor is concentrated at a smaller zone, thereby easily causing an uncomfortable sensation to a user.

In the preferred embodiment of the present invention, the heater 1 includes at least two surface mount resistors 21 and 22 electrically connected between the two copper foil plates 11 and 12. In such a manner, each of the two copper foil plates 11 and 12 is a heat conductor and can conduct the heat produced by the at least two surface mount resistors 21 and 22 so that the higher temperature produced by the at least two surface mount resistors 21 and 22 is distributed and diffused on each of the two copper foil plates 11 and 12 evenly and quickly. Thus, the two copper foil plates 11 and 12 can change and diffuse a spot-type temperature distribution of each of the at least two surface mount resistors 21 and 22 into a planar-type temperature distribution to distribute the temperature evenly and smoothly so as to instantly reduce the higher temperature produced by the at least two surface mount resistors 21 and 22 to a determined temperature that is comfortable to a user.

Still referring to FIG. 1, each of the two electric wires 31 and 32 is also a heat conductor to absorb the heat source, so that the surface mount resistor 22 proximate to the two electric wires 31 and 32 has a lower temperature, and the surface mount resistor 21 distal to the two electric wires 31 and 32 has a higher temperature, thereby producing a temperature differential between the at least two surface mount resistors 21 and 22.

In the preferred embodiment of the present invention, each of the two copper foil plates 11 and 12 has a first extension 111 and 121 extending from the surface mount resistor 22 and a second extension 110 and 120 extending from the surface mount resistor 2 1, wherein the second extension 110 and 120 of each of the two copper foil plates 11 and 12 has a length greater than that of the first extension 111 and 121. In such a manner, the second extension 110 and 120 of each of the two copper foil plates 11 and 12 has a larger area to diffuse and spread the greater heat produced by the surface mount resistor 21 so that the heat produced by the at least two surface mount resistors 21 and 22 is distributed on each of the two copper foil plates 11 and 12 evenly and smoothly.

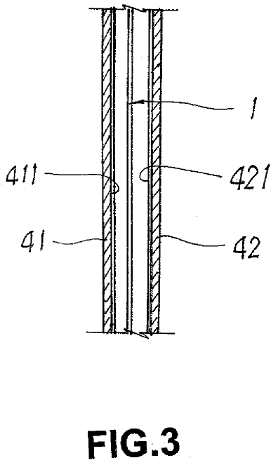

Referring to FIGS. 2 and 3, the surface mount resistor heating apparatus further comprises two cloth pieces 41 and 42 connected with each other to encompass the heater 1 between the two cloth pieces 41 and 42. Thus, the two cloth pieces 41 and 42 function as a heat insulating layer to protect the heater 1 so that the heater 1 has an uniform temperature. The two cloth pieces 41 and 42 have different heat insulating effects. Each of the two cloth pieces 41 and 42 has an area greater than that of the heater 1 and has a rim 410 and 420 protruding from the heater 1, wherein the rims 410 and 420 of the two cloth pieces 41 and 42 are connected by a stitching line 43 to combine the two cloth pieces 41 and 42 together. When in use, the rims 410 and 420 of the two cloth pieces 41 and 42 are attached to an article, such as a glove, clothing, hat, shoe cushion and the like, so as to heat the article by the heater 1.

Referring to FIGS. 1-3, the surface mount resistor heating apparatus further comprises two plastic films 411 and 421 connected with each other to encompass the heater 1 between the two plastic films 411 and 421. Thus, the two plastic films 411 and 421 function as a waterproof layer to protect the heater 1. The two plastic films 411 and 421 are heated and fused by heat pressing so that the two plastic films 411 and 421 are integrally combined together to encompass the heater 1 closely. Preferably, each of the two plastic films 411 and 421 are bonded onto an inner surface of each of the two cloth pieces 41 and 42 respectively so that the two plastic films 411 and 421 are located between the two cloth pieces 41 and 42. In such a manner, the heat produced by the at least two surface mount resistors 21 and 22 is distributed and diffused by each of the two copper foil plates 11 and 12, then absorbed by the two cloth pieces 41 and 42 respectively and finally released outwardly from the two cloth pieces 41 and 42 respectively, so that the surface mount resistor heating apparatus has a temperature profile that is distributed evenly and smoothly.

Accordingly, the surface mount resistor heating apparatus produces a proper temperature by an impedance of at least two surface mount resistors 21 and 22 to achieve a heating purpose. In addition, each of the two copper foil plates 11 and 12 can conduct the heat produced by the at least two surface mount resistors 21 and 22 so that the higher temperature produced by the at least two surface mount resistors 21 and 22 is distributed and diffused on each of the two copper foil plates 11 and 12 evenly and quickly. Further, the two copper foil plates 11 and 12 can change and diffuse a spot-type temperature distribution of each of the at least two surface mount resistors 21 and 22 into a planar-type temperature distribution to distribute the temperature evenly and smoothly so as to instantly reduce the higher temperature produced by the at least two surface mount resistors 21 and 22 to a determined temperature that is comfortable to a user. Further, the surface mount resistor heating apparatus has waterproof and heat insulating functions. Further, the heat produced by the at least two surface mount resistors 21 and 22 is distributed and diffused by each of the two copper foil plates 11 and 12, then absorbed by the two cloth pieces 41 and 42 respectively and finally released outwardly from the two cloth pieces 41 and 42 respectively, so that the surface mount resistor heating apparatus has a temperature profile that is distributed evenly and smoothly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A surface mount resistor heating apparatus, comprising a heater including two copper foil plates having a determined length and width and electrically connected to positive and negative electrodes of two electric wires, and at least two surface mount resistors electrically connected between the two copper foil plates, wherein when a low voltage electric power is applied onto the heater, the heater produces a temperature by an impedance of the at least two surface mount resistors to achieve a heating purpose.

2. The surface mount resistor heating apparatus in accordance with claim 1, wherein a first one of the at least two surface mount resistors is located between each of the two electric wires and a second one of the at least two surface mount resistors, each of the two copper foil plates has a first extension extending from the first one of the at least two surface mount resistors and a second extension extending from the second one of the at least two surface mount resistors, and the second extension of each of the two copper foil plates has a length greater than that of the first extension.

3. The surface mount resistor heating apparatus in accordance with claim 1, further comprising two cloth pieces connected with each other by stitching to encompass the heater between the two cloth pieces, wherein each of the two cloth pieces has an area greater than that of the heater.

4. The surface mount resistor heating apparatus in accordance with claim 3, further comprising two plastic films bonded onto the two cloth pieces respectively to encompass the heater between the two plastic films.

5. The surface mount resistor heating apparatus in accordance with claim 1, further comprising two thicker plastic films connected with each other by heat pressing to encompass the heater between the two plastic films.
